(19) United States
(12) Patent Application Publication
(10) Pub. No.: US 2025/0053865 A1
(43) Pub. Date: Feb. 13, 2025

(54) Preventing The Distribution Of Forbidden Network Content With Robustified Detection

(71) Applicant: Google LLC, Mountain View, CA (US)

(72) Inventors: Wei Qiao, Santa Clara, CA (US); Chun-Ta Lu, Sunnyvale, CA (US); Yinatao Liu, Union City, CA (US); Ariel Fuxman, Redwood City, CA (US); Mehmet Nejat Tek, Redwood City, CA (US); Dongjin Kwon, Sunnyvale, CA (US); Florian Nils Stimberg, London (GB)

(21) Appl. No.: 18/561,104

(22) PCT Filed: Dec. 14, 2022
(86) PCT No.: PCT/US2022/052814

§ 371 Date: Nov. 15, 2023

(51) Int. Cl. G06N 20/00; G06V 20/70

(52) U.S. Cl. CPC G06N 20/00; G06V 20/70

(57) ABSTRACT

The technology is generally directed to the training and execution of a model to identify policy violating content that has been obfuscated. The model may be trained using obfuscated training images. The obfuscated training images may be associated with one or more labels, such as a policy, obfuscation label, etc. The obfuscated training images and associated labels may be input into the model. During training, the output of the model may be a policy prediction as to whether the obfuscated input images violate the content policy of a host or are approved content for publishing. During implementation, the model may receive content as input and provide as output a policy prediction for the content. The host may use the policy prediction provided by the model to determine whether or not to publish the content.

### BACKGROUND

Attackers sometimes obfuscate malicious content within a publication such that a host unknowingly publishes the malicious content when publishing the publication. While filters may be used to reject content that is malicious, the obfuscated content may bypass filters, such that the malicious content is not detected and as a result may be unknowingly published by a host. Human review may be more effective in detecting obfuscated content, but requiring manual review of content to determine whether the obfuscated content is appropriate for publication is cumbersome, expensive, and time consuming.

### BRIEF SUMMARY

The present disclosure is generally directed to training and execution of a machine learning model to identify policy violating content that has been obfuscated. The model may be trained using obfuscated training images. The training images may include malicious content or any other content that violates one or more policies of a host. The obfuscated training images may be associated with one or more labels prior to training the model. Examples of such labels may include a policy label indicating a policy approval or policy violation, obfuscation label indicating a type of obfuscation applied to the training image, etc. The obfuscated training images and associated labels may be used to train the model. During training, the output of the model may be a policy prediction as to whether the obfuscated input images violate the content policy of a host or are approved content for publishing. Once the model has been trained, the model may be implemented in detecting policy-violating content. For example, during implementation the model may receive content as input and provide as output a policy prediction for the content. The host may use the policy prediction provided by the model to determine whether or not to publish the content.

One aspect of the technology is directed to a method, comprising receiving as input to a machine learning model, by the one or more processors, training images, wherein at least one of the training images is an obfuscated training image, associating, by one or more processors, at least one label of a first set of labels to respective training images, wherein the first set of labels includes policy labels relating to a policy for approving content for publication, and training, by the one or more processors based on the training images and the associated at least one label of the first set of labels, the machine learning model. The machine learning model may output policy predictions, and the policy predictions may include an indication of a violation or approval based on the respective policy labels. The policy labels may indicate a policy violation or a policy approval.

The method may further comprise associating, by the one or more processors, at least one label of a second set of labels to the respective training images, wherein the second set of labels includes obfuscation labels. The obfuscation labels may identify a type of obfuscation of a plurality of obfuscation types.

The method may further comprise executing the machine learning model to identify violative content. The executing may comprise receiving one or more images as input into the machine learning model, and determining, using the machine learning model, a policy prediction for each of the one or more images. The policy prediction for each of the one or more images may include an indication of a violation or approval. When the policy prediction includes the violation indication, the method may further include rejecting, by the one or more processors, the respective image such that the respective image is not provided for output. When the policy prediction includes the approval indication, the method may further include providing for output, by the one or more processors, the respective image.

The method may further comprise executing the machine learning model to identify violative content, the executing comprising detecting that the one or more images are one or more obfuscated images. The method may further comprise detecting the target concept of the one or more obfuscated images. The method may further comprise comparing the detected target concept to a host's target concept.

Another aspect of the technology is directed to a system, comprising one or more processors. The one or more processors may be configured to receive as input to a machine learning model training images, wherein at least one of the training images is an obfuscated training image, associate at least one label of a first set of labels to respective training images, wherein the first set of labels includes policy labels relating to a policy for approving content for publication, and train, based on the training images and the associated at least one label of the first set of labels, the machine learning model. The machine learning model may output policy predictions, and the policy predictions may include an indication of a violation or approval based on the respective policy labels.

Yet another aspect of the technology is directed to a computer-readable medium storing instructions which, when executed by one or more processors, cause the one or more processors to receive as input to a machine learning model training images, wherein at least one of the training images is an obfuscated training image, associate at least one label of a first set of labels to respective training images, wherein the first set of labels includes policy labels relating to a policy for approving content for publication, and train, based on the training images and the associated at least one label of the first set of labels, the machine learning model. The machine learning model may output policy predictions, and the policy predictions may include an indication of a violation or approval based on the respective policy labels.

### BRIEF DESCRIPTION OF THE DRAWINGS

FIG. 1 is a flow diagram for training and evaluating a machine learning model in accordance with aspects of the disclosure.

FIG. 2 are example obfuscated training images in accordance with aspects of the disclosure.

FIG. 3 is a flow diagram for an example method of executing the machine learning model in accordance with aspects of the disclosure.

FIG. 4A is a block diagram of an example system in accordance with aspects of the disclosure.

FIG. 4B is a pictorial diagram of the example system of FIG. 6A.

FIG. 5 is a flow diagram for an example method of training a machine learning model to identify policy violating content that has been obfuscated in accordance with aspects of the disclosure.

FIG. 6 is a flow diagram for an example method of executing a machine learning model to identify policy violating content that has been obfuscated in accordance with aspects of the disclosure.

### DETAILED DESCRIPTION

The present disclosure is generally directed to training and implementation of a model to identify policy violating content, such as malicious content that has been obfuscated. Obfuscated content may be any content, such as text, images, video, etc., that has been altered such that it is obscured. According to some examples, obfuscated content may include violative content that has been altered or manipulated by an attacker in order to bypass conventional content filters.

According to the present disclosure, a machine learning (“ML”) model may be trained using malicious content as training images. In some examples, the malicious content may be violative content, such as content that violates a content policy of a host. The training images may be obfuscated, using one or more obfuscation techniques, and input into the ML model. The obfuscated training images may be associated with a label that is used to train the model. The label may be a policy label indicating a policy approval or a policy violation. During the training stage, the output of the ML model may be a policy prediction as to whether the obfuscated input images violate the content policy of the host or are approved content for publishing.

During implementation, the ML model may receive content as input. The content may be content submitted to a host by third parties to be output by the host. The ML model may output a policy prediction for the content indicating whether the content violates the content policy or is approved in view of the content policy. The host may use the policy prediction provided by the ML model to determine whether or not to publish the content.

Training the ML model to predict whether the images include policy violations may be more computationally efficient as compared to identifying the underlying content that is obfuscated in the images. For example, the ML model may provide an indication of whether the input content violates the content policy or is approved based on the content policy. Because the system can make this determination without expending additional computing resources, such as processing power, memory, etc., to decipher what is portrayed in an obfuscated image, this may save the system time and processing power, thereby making the system more efficient in determining whether input content violates a content policy. According to some examples, the ML model does not predict what is in the input content nor does the ML model attempt to de-obfuscate the input content. By not predicting what is in the input content and/or attempting to de-obfuscate the input content, the system may save time and processing power, thereby making the system more efficient. Adding the obfuscated images into the training data makes the model robust to image obfuscations such that the model's accuracy in detecting policy violating content may be improved. Using domain generalization techniques in the model training may make the model generalized to unseen obfuscations. A regularization approach, which may be Maximum Mean Discrepancy (MMD) regularization or Central Moment Discrepancy (CMD) regularization, may be incorporated into the model training by adding an additional domain regularization loss into the total loss function to encourage the unobfuscated and the obfuscated images to have similar embeddings so that a universal representation may be generalized well to the unseen obfuscations.

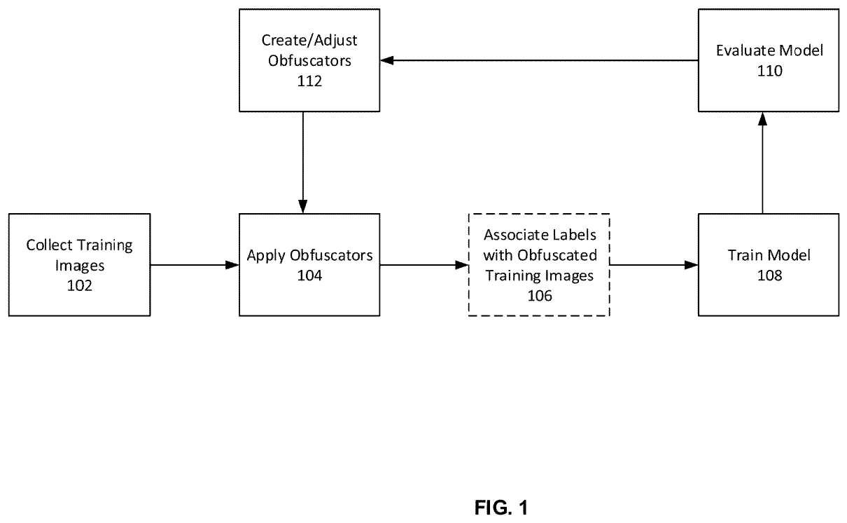

FIG. 1 is an example method of training a ML model. Training the model may include collecting training images 102, applying obfuscators 104, associating labels with obfuscated training images 106, training the model 108, evaluating the model 110, and creating and/or adjusting the obfuscators 112.

Collecting training images 102 for the ML model may include obtaining images that have been collected or generated from content that has been received by the system for approval to be published. The content may be intended to be published as content on a website. For example, the system may receive content in the form of an advertisement to be published on a website, in response to a user's search query, etc. The training images may be, in some examples, content that has been previously rejected for policy violations. In some examples, the training image may include content that has been approved for publishing. The model training 108 may include obfuscated images and/or non-obfuscated images.

Applying obfuscators 104 may include applying one or more obfuscations to the training images. The obfuscations may obscure, blur, jumble, alter, etc. the training images. Examples of obfuscation types include cut and paste, icon overlay, filter overlay, image overlay, line overlay, static overlay, transform filtering, transform fusing, transform halftoning, transform quantizing, style transferring, transform warping, etc. According to some examples, the obfuscations may be perturbations. Image perturbations may transform or alter the image such that the content may not recognize the original image. The obfuscated training images may be provided as input into the ML model.

The obfuscated content may, in some examples, preserve a desired property related to the content. The desired property may be, for example, a target concept. For example, if the host is selling toys, the target concept may be toys. In such an example, regardless of the obfuscations applied to the content, the obfuscated content may maintain an indication of the target concept.

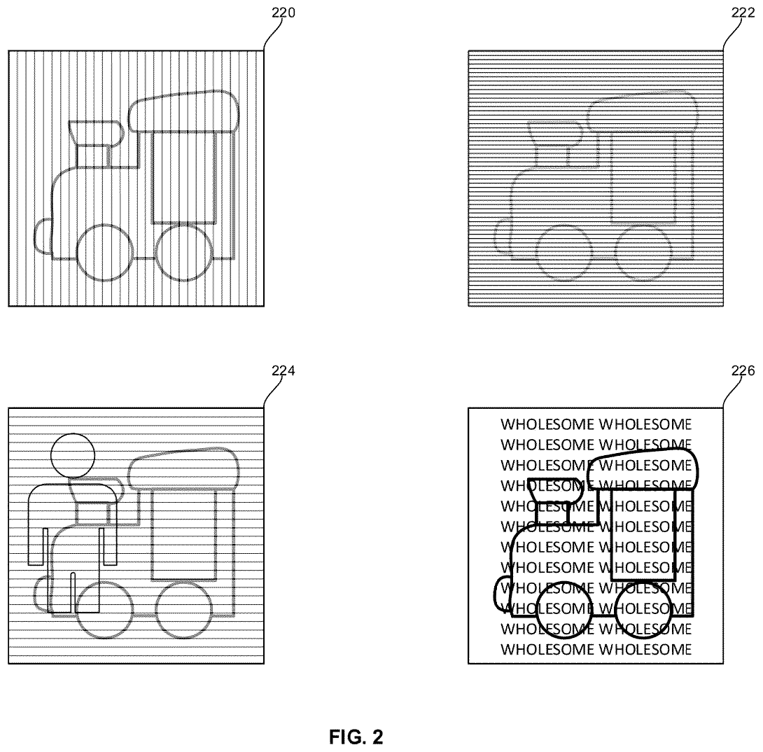

As shown in FIG. 2, the training image may be an image of content that was previously approved for publishing. As shown, the training image may be of a train. While the content of the training image shown in FIG. 2 is content that was previously approved for publishing, the training image may be an image of content that was previously rejected for policy violations. The image of the train is just one example of the training image and, therefore, is not intended to be limiting.

One or more obfuscators may be applied to the training image to alter, obscure, manipulate, etc. the image of the train. Training image 220 illustrates an example of a line overlay obfuscator being applied to the training image. Training image 222 illustrates an example of a transform halftoning obfuscator being applied to the training image. Training image 224 illustrates an example of a transform fusing obfuscator being applied to the training image. Training image 226 illustrates an example of a static overlay obfuscator being applied to the training image. While each training image 220-226 illustrates only one obfuscator being applied to the training image, a plurality of obfuscators may be applied to the training images. Accordingly, training images 220-226 and their respective obfuscators are only some examples and are not intended to be limiting.

Referring back to FIG. 1, in some examples, the collected training images 102 may optionally include obfuscated training images. In some examples, if the collected training image is already obfuscated, one or more additional obfuscators may be applied to the training image. Additionally or alternatively, if the collected training image is already obfuscated, applying obfuscators 104 may be optional such that no additional obfuscators are applied to the training images.

According to some examples, training the model may include associating labels with the obfuscated training images 106. For example, a reviewer may attach a first set of labels to the obfuscated training images. For example, each obfuscated training image may be associated with at least one label of the first set of labels. The first set of labels may include policy labels, providing an indication of whether the training image includes a policy violation, such as if the content violates the content policy, or a policy approval, such as if the content can be published without violating the content policy. Policy violating content may be, for example, content that the host has deemed inappropriate for outputting to the users, viewers, readers, etc. of the website. For example, if the host is a retailer selling toys for children, the host's content policy may indicate that content with foul language is policy violating content for the host's website.

According to some examples, a second set of labels may be associated with the obfuscated training images and provided as input into the ML model. For example, each obfuscated training image may be associated with at least one label of the second set of labels. The second set of labels may include obfuscation labels. The obfuscation labels may indicate at least one type of obfuscation present in the training images. The types of obfuscation may include, for example, one or more of line overlay, transform halftoning, transform fusing, static overlay, etc.

In some examples, the training images 102 may be associated with the first or second labels without human review or intervention. For example, where the training images includes content that has been previously rejected for policy violations, the training images may have already been tagged with an associated label indicating a policy violation. In examples where the training images include content that has been previously approved for publishing, the collected training images may have automatically been tagged with an associated label indicating policy approval.

In some examples, the obfuscated training images 104 may be automatically associated with an obfuscation label when the obfuscation is applied 104. In further examples, when associating obfuscation labels with the obfuscated training images 106, policy labels may be automatically applied, such as if any obfuscated image would result in a policy violation.

In some examples, the collected training images 102 may already include associated first and/or second labels at a time of collection. In some examples, if the collected training images 102 already include associated first and second labels, associating labels with the obfuscated training images 106 may include confirming the associated labels and/or associating additional labels with the obfuscated training images. The additional labels may be different from the labels previously associated with the obfuscated training images.

At block 108, the model may be trained. The ML model may be trained using the obfuscated training images 104 and associated labels 106 to provide a policy prediction based on the respective policy labels. According to some examples, the ML model may, additionally or alternatively, be trained using unobfuscated images and associated labels 106 to provide a policy prediction based on the respective policy labels. The unobfuscated images may be, for example, the original training image before an obfuscator is applied. The policy prediction may be, for example, an indication that the content violates the content policy or an indication that the content has been approved for publishing. In examples where the ML model is trained with a second set of labels, the ML model may be trained to also provide an obfuscation prediction based on the respective obfuscation labels.

According to some examples, the model may be a Domain-Adversarial Neural Network (“DANN”). In an adversarial model, such as a DANN, the model may be trained using labeled obfuscated training images. Rather than having one prediction head for predicting policy violations, the DANN may have two predictions heads for predicting policy violations and obfuscation types. The prediction head that provides a policy prediction may be the a primary prediction head and the prediction head that provides an obfuscation prediction of the obfuscation type may be an adversarial head. The adversarial objective, e.g., the obfuscation type prediction, from the adversarial head may be implemented by reversing the gradient of the obfuscation type.

According to some examples, the obfuscated training images may be used to obtain pretrained embeddings. The pretrained embeddings may be obtained using a frozen deep model. The deep frozen model may produce the embeddings for the training images. According to some examples, the deep frozen model may produce the embeddings for both the original training images, e.g., the non-obfuscated training images, and the obfuscated training images. The embeddings produced by the frozen model may be used to train the DANN, or other models used to predict policy violations. A shallow model may be trained using the obfuscated training images and the pretrained embeddings. According to some examples, the shallow model may be fast to retrain thereby allowing for fast inferences to be made. In examples where the DANN model has one prediction head, the shallow model may, in some examples, provide policy predictions as output. In examples where the DANN model has two prediction heads, the shallow model may provide policy predictions and obfuscation predictions as outputs. The output of the DANN may include robust embedding. For example, the DANN, or any other model used to predict policy violations, may predict the policy label and/or obfuscation label and may, additionally or alternatively, produce robust embeddings of input images. According to some examples, by producing the robust embedding of an image, similar images, whether the images are obfuscated or not, may be grouped close to one another in the embedding space. The embedding space may be a N-dimensional space, where N is the length of the embedding vector. Grouping similar images in the embedding space based on the robust embedding may result in the distance between the embeddings of the two images being less than a threshold. According to some examples, DANN may promote the embedded parameters to be discriminative for the primary learning task, e.g., policy predictions, and indiscriminate with respect to the shift between obfuscations, making the neural network robust to obfuscations even if those obfuscations are not included in the training data.

A final loss function of the DANN may be a weighted linear combination of both heads. The final loss function may be used to evaluate the label predictions as the objective function. According to some examples, the loss function may be a combination of both the obfuscation label prediction and the policy violating prediction, corresponding to the two prediction heads, respectively. The loss function may be the objective function to minimize, as a lower cost score may indicate a lower prediction error rate. The optimization may be a minimum-maximum game to minimize the standard loss and domain loss with respect to the obfuscation type while maximizing the domain loss with respect to the embedded parameters.

According to some examples, the content of the image may be significantly altered by the obfuscations but the image may preserve a desired property. The desired property may be, for example, the target concept of the image, such as the genre, topic, focus, etc. of the image. The desired property, or target concept, may be one of the losses of the DANN model.

The model may be trained using a regularization-based approach. The regulation loss may encourage two or more distributions to be indistinguishable. For example, the total loss may correspond to the aggregate of the supervised loss and the domain regularization loss. Examples of regularizations include maximum mean discrepancy (“MMD”) and central moment discrepancy (“CMD”). MMD regularization may embed the given distributions into kernel space and may maximize the difference between the means in the kernel space. CMD regularization may minimize the difference between means, variances, and higher order moments for the distributions, as opposed to using kernel space. The outlined approaches promote the embedded parameters to be invariant to the distribution shifts owing to obfuscations.

According to some examples, when training the ML model using the regularization-based approach, the obfuscated training images may be used to obtain obfuscated embedding. According to some examples, the embedding may be a vector representation of the image. The obfuscated embedding may be obtained using a deep frozen model. The deep frozen model may produce the embeddings for the training images. According to some examples, the deep frozen model may produce the embeddings for both the original training images, e.g., the non-obfuscated training images, and the obfuscated training images. The embeddings produced by the frozen model may be used to train the model used to predict policy violations. A model may be trained based on the obfuscated training images and/or the obfuscated embedding. The model may provide a policy prediction as output. According to some examples, the output of the shallow model may include robust embedding.

The model can repeat the training 108 multiple times, until meeting one or more stopping criteria. The stopping criteria can include, for example, a maximum number of training iterations and/or, for supervised learning or semi-supervised learning, iterations of backpropagation, gradient descent, and model parameter update. The stopping criteria can additionally or alternatively define a minimum improvement between training iterations. For semi-supervised training, an example can be a relative or absolute reduction in the computed error between output predicted by the model and corresponding ground-truth labels on training data reserved for validation and/or testing. For unsupervised learning, an example loss function can be least squares.

In some examples, the model can be trained for a number of epochs, e.g., 1000 epochs with early stopping where an error between a predicted output and ground-truth error is not improved over 10 epochs. Other stopping criteria can be based on a maximum amount of computing resources allocated for training, for example a total amount of training time exceeded, e.g., wall clock time, or total number of processing cycles consumed, after which training is terminated.

The ML model may be evaluated 110. The ML model may be evaluated based on the type of obfuscator applied to the training image on an unlabeled image dataset collected from the network and a pre-estimated labeled image dataset. For example, if the ML model performs poorly in predicting policy violations under a particular type of obfuscation, the type of obfuscator may be adjusted to create more effective obfuscated training images under such type of obfuscation. Instead of using fixed hyperparameters, the hyperparameters of the particular obfuscator may be tuned and randomized within the parameter ranges. According to some examples, the hyperparameters may be determined by an implementer based on human perception of the image semantic. In some examples, the hyperparameter of the particular obfuscator may be determined to make obfuscated training images more diverse for this particular type of obfuscation. Additionally or alternatively, more obfuscated training images using this particular type of obfuscator may be added to the set of training images.

In some examples, if the ML model performs poorly in predicting policy violation under a particular type of obfuscation and this particular type of obfuscation is not included in the training data, a new obfuscator may be created 112 in order to create more effective obfuscated training images under such type of obfuscation to cover the missing coverage of this particular type of obfuscation. According to some examples, generative ML models may be used to synthesize the particular type of obfuscation.

According to some examples, the ML model may be configured with a regression analysis technique that uses a statistical process to estimate the relationship between a feature or combination of features and a signal. The feature or combination of features can be a predictor or independent variable, and the signal can be a dependent variable or a criterion variable that can change as the features are varied. According to some examples, the feature may be, for example, the content of the training images and the signal may be, for example, the obfuscation applied to the training images.

In some cases, the ML model can estimate or determine a conditional expectation of the dependent variable given the independent variables, such as an average value of the dependent variable when the independent variables are fixed, or other parameter or metric of the conditional distribution of the dependent variable or signal given the independent variable or feature. The predicted signal can be a function of the independent variables and can be referred to as a regression function. According to some examples, the predicted signal may be a policy prediction, such as whether the content violates the content policy or is approved content in view of the content policy.

The ML model can further identify, determine, or characterize a variation of the dependent variable around the regression function which can be described by a probability distribution. The ML model can use the probability distribution to generate a confidence score in the predicted signal value or use the probability distribution as the confidence score. The ML model may use the generated configured score when evaluating the model 110.

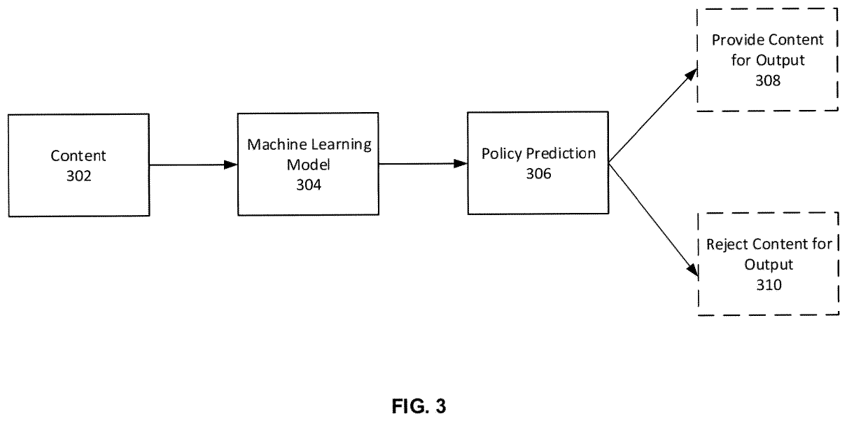

FIG. 3 illustrates an example method of applying the ML model. When executing the ML model to detect policy violating content, the system may receive content 302 and input the received content into the ML model 304. The ML model may output a policy prediction 306. Based on the policy prediction 306, the system may provide content for output 308 or reject content for output 310.

The system may receive content 302, such as images, to be input into the ML model. According to some examples, the content received by the host may be malicious content that has been obfuscated. The received content 302 may be content that is input into the ML model 304.

The ML model may output a policy prediction 306 for the input content. The policy prediction may be an indication of a content policy violation or a content policy approval. In examples where the policy prediction includes an indication that the input content violates the content policy, the system may reject the received content such that the content is not provided for output. For example, content has been identified as violating the content policy may not be published.

According to some examples, content that has been identified as violating the content policy may automatically be rejected for publication by the host. Using the ML model may save time and processing power in determining whether content violates the content policy. In some examples, automatically rejecting content that has been identified as content policy violating content may save time and processing power in determining whether content can, or should, be published by the host.

In examples where the policy prediction includes an indication that the input content is approved, the system may provide the content for output 308. In such an example, content that has been identified as approved may be published. According to some examples, using the ML model may increase the efficiency in identifying whether content is approved for publishing based on the content policy. In some examples, the ML model may, additionally or alternatively, save time and processing power when determining whether content violates the content policy.

In examples where the ML model was trained with policy prediction labels and obfuscation labels, the ML model may output an obfuscation prediction for the input content. The obfuscation predictions may be a predicted type of obfuscation.

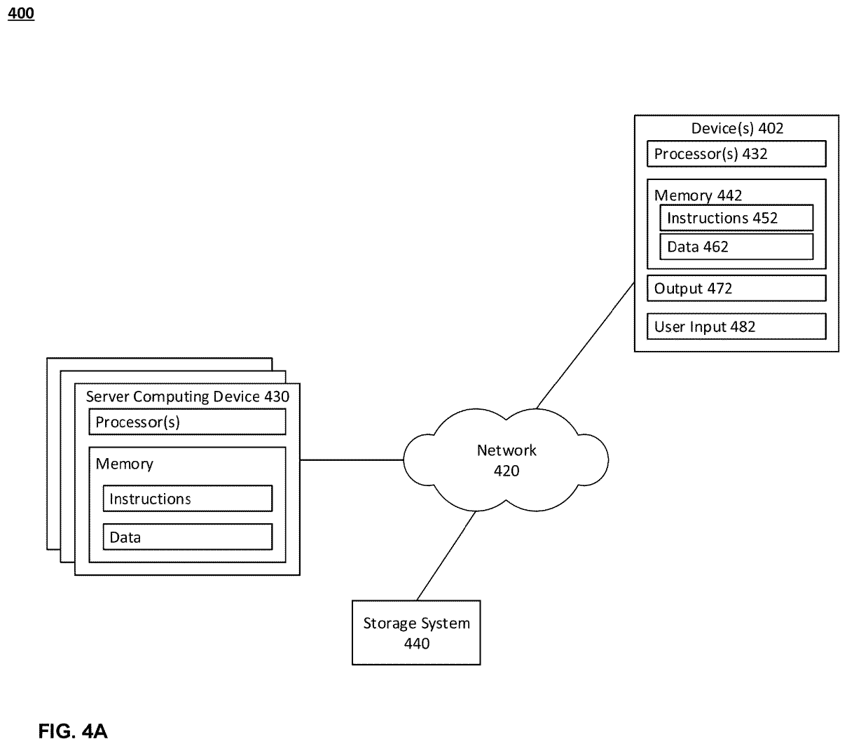

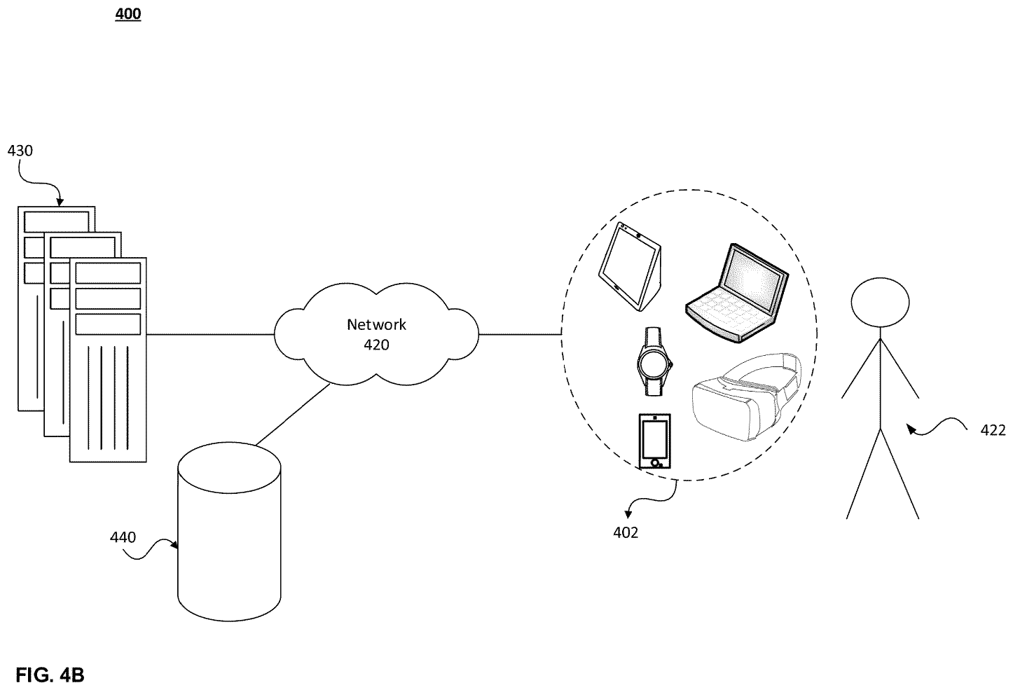

FIG. 4A illustrates an example system 400 in which the features described above may be implemented. It should not be considered limiting the scope of the disclosure or usefulness of the features described herein. In this example, system 400 may include device(s) 402, server computing device 430, storage system 440, and network 420.

Each of devices 402 may include one or more processors 432, memory 442, data 462 and instructions 452. Each of devices 402 may also include an output 472 and user input 482. The devices 402 may be, for example, a smart phone, tablet, laptop, smart watch, AR/VR headset, smart helmet, etc., as shown in FIG. 4B.

Memory 442 of devices 402 may store information that is accessible by processor 432. Memory 442 may also include data that can be retrieved, manipulated or stored by the processor 432. The memory 442 may be of any non-transitory type capable of storing information accessible by the processor 432, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 442 may store information that is accessible by the processors 432, including instructions 452 that may be executed by processors 432, and data 462.

Data 462 may be retrieved, stored or modified by processors 432 in accordance with instructions 452. For instance, although the present disclosure is not limited by a particular data structure, the data 462 may be stored in computer registers, in a relational database as a table having a plurality of different fields and records, XML documents, or flat files. The data 462 may also be formatted in a computer-readable format such as, but not limited to, binary values, ASCII or Unicode. By further way of example only, the data 462 may comprise information sufficient to identify the relevant information, such as numbers, descriptive text, proprietary codes, pointers, references to data stored in other memories (including other network locations) or information that is used by a function to calculate the relevant data.

The instructions 452 can be any set of instructions to be executed directly, such as machine code, or indirectly, such as scripts, by the processor 432. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 432 may include any conventional processors, such as a commercially available CPU or microprocessor. Alternatively, the processor can be a dedicated component such as an ASIC or other hardware-based processor. Although not necessary, computing devices 402 may include specialized hardware components to perform specific computing functions faster or more efficiently.

Although FIG. 4A functionally illustrates the processor, memory, and other elements of devices 402 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the devices 402. Accordingly, references to a processor or device will be understood to include references to a collection of processors or devices or memories that may or may not operate in parallel.

Output 472 may be a display, such as a monitor having a screen, a touchscreen, a projector, or a television. The display processors of the one or more computing devices 402 may electronically display information to a user via a graphical user interface (“GUI”) or other types of user interfaces. For example, as will be discussed below, display processors may electronically display a content, a publication, etc. The content may be, for example, an advertisement. The publication may be published by a host, such as a host of a website.

The user input 482 may be a mouse, keyboard, touchscreen, microphone, or any other type of input. The user input may receive a submission of content from a user. For example, the user can select content to be submitted to a host for publishing.

The devices 402 can be at various nodes of a network 420 and capable of directly and indirectly communicating with other nodes of network 420. Although a single computing device is depicted in FIG. 4A, it should be appreciated that a typical system can include one or more computing devices, with each computing device being at a different node of network 420. The network 420 and intervening nodes described herein can be interconnected using various protocols and systems, such that the network can be part of the Internet, World Wide Web, specific intranets, wide area networks, or local networks. The network 420 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 400 may include one or more server computing devices 430 having a plurality of computing devices, e.g., a load balanced server farm, that exchange information with different nodes of a network for the purpose of receiving, processing and transmitting the data to and from other computing devices. For instance, one or more server computing devices 430 may be a web server that is capable of communicating with the one or more client computing devices 402 via the network 420. In addition, server computing device 430 may use network 420 to transmit and present information to a user of one of the other computing devices 402. Server computing device 430 may include one or more processors, memory, instructions, data, location sensors, etc. These components operate in the same or similar fashion as those described above with respect to computing devices 402.

As shown in FIG. 4B, each device 402 may be a personal computing device intended for use by a respective user 422, and have all of the components normally used in connection with a personal computing device including one or more processors (e.g., a central processing unit (CPU)), memory (e.g., RAM and internal hard drives) storing data and instructions, an output, such as a display (e.g., a monitor having a screen, a touch-screen, a projector, a television, or other device such as a smart watch display that is operable to display information), and user input devices (e.g., a mouse, keyboard, touchscreen or microphone). The devices may also include a camera for recording video streams, speakers, a network interface device, and all of the components used for connecting these elements to one another. Devices 402 may be capable of wirelessly exchanging or obtaining data over the network 420.

Although the client computing devices may each comprise a full-sized personal computing device, they may alternatively comprise mobile computing devices capable of wirelessly exchanging data with a server over a network such as the Internet. By way of example only, devices 402 may be mobile phones or devices such as a wireless-enabled PDA, smartphones, a tablet PC, a wearable computing device (e.g., a smartwatch, AR/VR headset, smart helmet, etc.), or a netbook that is capable of obtaining information via the Internet or other networks.

Storage system 440 may store various types of information. For instance, the storage system 440 may store data, information, content, or training images. In some examples, storage system 440 may store data or information related to content policies for one or more hosts.

Storage system 440 may store data or information related to the training images, such as labels associated with the training images. The labels may be, for example, policy labels, obfuscations labels, etc. Policy labels may include an indication of whether the content violates the content policy of a host or is approved for publishing in view of the content policy of the host.

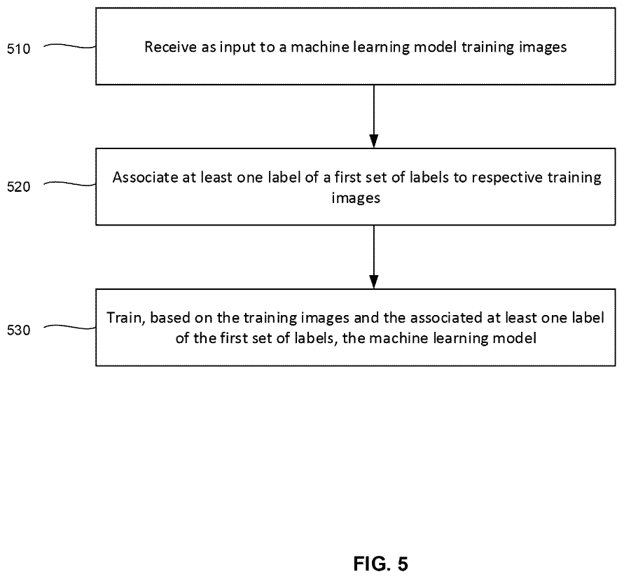

FIG. 5 illustrates an example method for training a ML model to identify policy violating content that been obfuscated. The following operations do not have to be performed in the precise order described below. Rather, various operations can be handled in a different order or simultaneously, and operations may be added or omitted.

In block 510, training images may be received as input to a ML model. The training images may include at least one obfuscated training image. According to some examples, the training images may be collected or generated from content that has been received by the system. For example, the system may receive content to be published in a publication, such as a website, in response to a user's search query, etc. The content may be, for example, in the form of an advertisement.

In some examples, the training images may be content that was previously rejected as violating the content policy. Additionally or alternatively, the training images may be content that was previously approved to be published. According to some examples, the training images may be obfuscated content. In some examples, one or more obfuscators may be applied to the training images.

In block 520, at least one label of a first set of labels may be associated with respective obfuscated training images. The first set of labels may include policy labels relating to a policy for approving content for publication. The policy label may indicate a policy violation or a policy approval.

In some examples, at least one label of a second set of labels may be associated with the respective training images. The second set of labels may include obfuscation labels. The obfuscation labels may identify a type of obfuscation of a plurality of obfuscations. Types of obfuscations include, for example, cut and paste, icon overlay, filter overlay, image overlay, line overlay, static overlay, transform filtering, transform fusing, transform halftoning, transform quantizing, style transferring, transform warping, etc.

In block 530, the ML model may be trained based on the training images and the associated label of the first set of labels. In examples where a label of the second set of labels is associated with the obfuscated training images, the ML model may be trained based on the obfuscated training images and one or both of the first and second labels.

The ML model may be trained to provide a policy prediction based on the respective policy labels. The policy prediction may include, for example, an indication of a violation or approval based on the respective policy labels. In examples where the ML model is trained with the second set of labels, the ML model may be trained to provide, in addition to the policy prediction, an obfuscation prediction based on the obfuscation label.

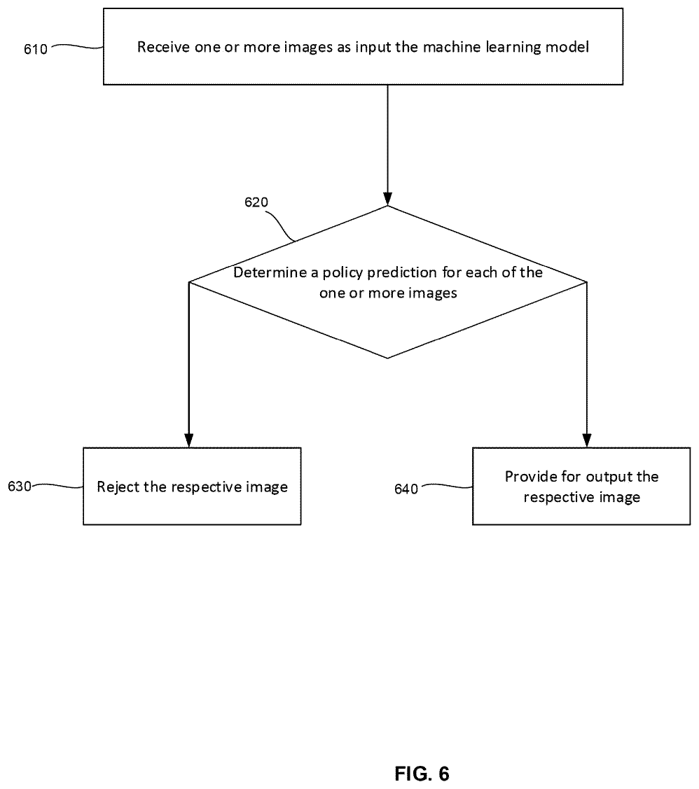

FIG. 6 illustrates an example method for applying the ML model to detect policy violating content. The following operations do not have to be performed in the precise order described below. Rather, various operations can be handled in a different order or simultaneously, and operations may be added or omitted.

In block 610, the ML model may receive one or more images as input into the ML model. The images may be, for example, images submitted by third parties to a host to be published on the host's website. According to some examples, the received images may be malicious or violative content that has been obfuscated.

In block 620, the ML model may determine a policy prediction for each image received as input into the ML model. The policy prediction for each image may include an indication of a violation or approval.

In block 630, when the policy prediction includes the violation indication, the violative image may be rejected such that the violative image is not provided for output. According to some examples, images that have been identified as violating the content policy of a host may automatically be rejected for publication by the host. In such an example, the image may not be published by the host. In some examples, images that have been identified as violating the content policy of the host may be automatically rejected for publication, thereby saving time and processing power in determining whether the image can, or should, be published by the host.

In block 640, when the policy prediction includes the approval indication, the approved image may be provided for output by the host. According to some examples, images that have been identified as approved images in view of the host's content policy may be automatically approved for publication by the host. According to some examples, using the ML model may increase the efficiency of identifying whether the image is approved for publishing based on the host's content policy. Additionally or alternatively, the ML model may save time and processing power when determining whether the image violates or conforms to the content policy.

According to some examples, the ML model may detect that the received input images includes one or more obfuscated images. In some examples, the target concept of the obfuscated images may be detected. The target concept may be, for example, the genre, topic, focus, etc. of the image. For example, if the host is selling clothing, the target concept of images submitted to the host may be advertisements related to clothing. The obfuscated images may preserve the target concept, e.g., clothing, while altering the image. The ML model may detect that the received images are obfuscated but still preserve the target concept. Referring back to FIG. 2, the target concept of the obfuscated images may be toys. The target concept may be preserved even though the images have been obfuscated. The target concept of the image may be compared to the target concept of the host when determining whether the image violates the content policy of the host. In examples where the target concept of the image and the target concept of the host are the same, the ML model may proceed with making a policy violation determination. In examples where the target concept of the image and the target concept of the host are not the same, the ML model may reject the image. For example, if the target concept of the host is books and the target concept of the image is toys, as shown in FIG. 2, the ML model may reject the image.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples: rather, the examples are intended to illustrate only one of many possible implementations. Further, the same reference numbers in different drawings can identify the same or similar elements.

1. A method, comprising:
receiving as input to a machine learning model, by one or more processors, training images, wherein the training images includes at least one obfuscated training image;
associating, by the one or more processors, at least one label of a first set of labels to respective training images, wherein the first set of labels includes policy labels relating to a policy for approving content for publication; and
training, by the one or more processors based on the training images and the associated at least one label of the first set of labels, the machine learning model, wherein:
the machine learning model outputs policy predictions, and
the policy predictions include an indication of a violation or approval based on the respective policy labels.

2. The method of claim 1, wherein the policy labels indicate a policy violation or a policy approval.

3. The method of claim 1, further comprising associating, by the one or more processors, at least one label of a second set of labels to the respective training images, wherein the second set of labels includes obfuscation labels.

4. The method of claim 3, wherein the obfuscation labels identify a type of obfuscation of a plurality of obfuscation types.

5. The method of claim 1, further comprising executing the machine learning model to identify violative content, the executing comprising:
receiving one or more images as input into the machine learning model; and
determining, using the machine learning model, a policy prediction for each of the one or more images.

6. The method of claim 5, wherein the policy prediction for each of the one or more images includes an indication of a violation or approval.

7. The method of claim 6, wherein when the policy prediction includes the violation indication, the method further includes rejecting, by the one or more processors, the respective image such that the respective image is not provided for output.

8. The method of claim 6, wherein when the policy prediction includes the approval indication, the method further includes providing for output, by the one or more processors, the respective image.

9. The method of claim 1, further executing the machine learning model to identify violative content, the executing comprising detecting that the one or more images are one or more obfuscated images.

10. The method of claim 9, further comprising detecting target concept of the one or more obfuscated images.

11. The method of claim 10, further comprising comparing the detected target concept to a host's target concept.

12. A system, comprising:
one or more processors, the one or more processors configured to:
receive as input to a machine learning model training images, wherein the training images includes at least one obfuscated training image;
associate at least one label of a first set of labels to respective training images, wherein the first set of labels includes policy labels relating to a policy for approving content for publication; and
train, based on the training images and the associated at least one label of the first set of labels, the machine learning model, wherein:
the machine learning model outputs policy predictions, and
the policy predictions include an indication of a violation or approval based on the respective policy labels.

13. The system of claim 12, wherein the policy labels indicate a policy violation or a policy approval.

14. The system of claim 12, wherein the one or more processors are further configured to associate at least one label of a second set of labels to the respective training images, wherein the second set of labels includes obfuscation labels.

15. The system of claim 14, wherein the obfuscation labels identify a type of obfuscation of a plurality of obfuscation types.

16. The system of claim 15, wherein the one or more processors are further configured to execute the machine learning model to identify violative content, the executing comprising:
receiving one or more images as input into the machine learning model; and
determining, using the machine learning model, a policy prediction for each of the one or more images.

17. The system of claim 16, wherein the policy prediction for each of the one or more images includes an indication of a violation or approval.

18. The system of claim 17, wherein when the policy prediction includes the violation indication, the one or more processors are further configured to reject the respective image such that the respective image is not provided for output.

19. The system of claim 17, wherein when the policy prediction includes the approval indication, the one or more processors are further configured to provide for output the respective image.

20. A non-transitory computer-readable medium storing instructions which, when executed by one or more processors, cause the one or more processors to:
receive as input to a machine learning model training images, wherein the training images includes at least one obfuscated training image;
associate at least one label of a first set of labels to respective training images, wherein the first set of labels includes policy labels relating to a policy for approving content for publication; and
train, based on the training images and the associated at least one label of the first set of labels, the machine learning model, wherein:
the machine learning model outputs policy predictions, and
the policy predictions include an indication of a violation or approval based on the respective policy labels.
